(19) United States
(12) Patent Application Publication
(10) Pub. No.: US 2026/0355732 A1
(43) Pub. Date: Nov. 12, 2026

(54) CONTINUOUS PROCESS FOR SEPARATING STRONTIUM CATIONS FROM A LIQUID MEDIUM, WITH A MATERIAL COMPRISING A GEOPOLYMER AND PARTICLES OF AN ION EXCHANGER

(71) Applicants: COMMISSARIAT A L'ENERGIE ATOMIQUE ET AUX ENERGIES ALTERNATIVES, Paris (FR); ORANO RECYCLAGE, Chatillon (FR)

(72) Inventors: Alban GOSSARD, Avignon (FR); Agnès GRANDJEAN, Saint-Marcel-De-Careiret (FR); Yves BARRE, Uchaux (FR); Audrey HERTZ, Bagnols-Sur-Ceze (FR)

(73) Assignees: COMMISSARIAT A L'ENERGIE ATOMIQUE ET AUX ENERGIES ALTERNATIVES, Paris (FR); ORANO RECYCLAGE, Chatillon (FR)

(21) Appl. No.: 19/139,284

(22) PCT Filed: Dec. 15, 2023
(86) PCT No.: PCT/FR2023/052021

§ 371 Date: Jul. 1, 2025

(30) Foreign Application Priority Data
Dec. 16, 2022 (FR) FR2213576

(51) Int. Cl. B01J 39/02; B01J 39/10; B01J 47/018; B01J 47/02; G21F 9/12

(52) U.S. Cl. CPC B01J 39/02; B01J 39/10; B01J 47/018; B01J 47/02; G21F 9/12

(57) ABSTRACT

A continuous process for separating at least one strontium cation, and in particular at least one cation of a radioactive isotope of strontium such as ⁹⁰Sr, from a liquid medium containing the same. In the process the liquid medium is brought into contact with a solid mesoporous material, comprising an inorganic matrix made of a mesoporous geopolymer having an open mesoporosity, said geopolymer having a single porosity scale, and particles of at least one solid inorganic exchanger compound which is selective for the strontium cations and is distinct from the geopolymer, these particles being distributed in the open mesoporosity of the inorganic matrix and being accessible to the strontium cations contained in the liquid medium; said solid mesoporous material being in the form of non-powdery grains forming a fixed bed, in particular forming a column packing.

### TECHNICAL FIELD

The invention relates to a continuous process for separating strontium (Sr) cations from a liquid medium, with a material comprising a geopolymer and particles of an ion exchanger, said material being in the form of non-powdery particles forming a fixed bed, for example forming a column packing.

The term ‘continuous process’ is understood to mean a process that is implemented continuously.

The invention more particularly applies to the field of treating liquid effluents and, in particular, that of treating radioactive or toxic liquid effluents with a view to removing strontium cations, in particular cations of radioactive strontium isotopes such as ⁹⁰Sr.

It should be noted that, in this document, the terms “adsorbent”, “ion exchanger”, “cation exchanger” and “exchanger of a cation” can be used indifferently and all refer to a “cation exchanger”.

### PRIOR ART

The materials currently used in the columns to decontaminate liquids containing strontium (Sr) cations—and in particular radioactive isotopes thereof including strontium 90—are materials based on agglomerated powders in the form of pellets.

These pellets typically comprise an ion exchanger such as a zeolite or a crystalline silicotitanate which are the most selective for strontium cations, as well as a binder.

The binder of the pellets is typically non-porous or slightly porous, which results in a loss of efficacy when using these pellets in column, fixed-bed treatment methods.

Indeed, the inside of the pellets is difficult to access, or is even inaccessible to the effluent to be treated and the specific exchange surface is therefore very small.

These materials thus have slow sorption kinetics (due to the low porosity or even the non-porosity of the binder) and a very small proportion of the available active sites is used, which leads to a decrease in Sr decontamination capacities and consequently an increase in the quantity of material necessary to decontaminate a given volume.

Moreover, numerous publications are available in the literature regarding the use of geopolymers for treating effluents.

The geopolymers for Sr cation decontamination are not selective and this results in the use of a large quantity of materials and therefore also in the formation of a large quantity of waste.

Document [1] describes the synthesis of geopolymers and geopolymer composite materials comprising additives. However, this document does not mention any specific application for these composite materials, and in particular does not mention any application of these materials for treating effluents in fixed bed methods, and even less for selectively extracting Sr in fixed bed methods.

In the context of the specific application of the invention for the selective extraction of Sr in fixed bed methods, the additive must be carefully identified and selected before its integration into the geopolymer, in order to possess ion exchange properties which are selective for Sr according to the effluents to be treated. This is not at all discussed in document [1].

Document [1] also does not give any indications that could ensure optimal use of the material of this document in a fixed bed method in a column. Indeed, such use requires specific shaping of the material packing the column in order to ensure that the properties of this material, such as its capacity and selectivity, in particular for Sr, are optimal, while limiting head losses throughout the plant integrating the column.

Document [2] describes a method for preparing a material consisting of a monolithic geopolymer foam comprising nanoparticles of a metal coordination polymer with CN ligands of the formula [Alk⁺ₓ]Mⁿ⁺[M′(CN)ₘ]^{z-}.

This document further relates to the foam prepared by this method, and the use of this foam to separate a metal or metalloid ion from a stream containing said metal or metalloid ion.

The method for preparing this foam comprises several steps. During a first step a), a geopolymer foam is brought into contact with a solution containing at least one Mⁿ⁺ ion. Then, during a second step b), the geopolymer foam obtained at the end of step a) is brought into contact with a solution of a salt or complex of [M′(CN)ₘ]^{z-} and at least one alkali metal salt, whereby the geopolymer foam comprising nanoparticles of a metal coordination polymer is obtained.

This multi-step method complicates the overall synthesis of the material, making it difficult to transpose it to an industrial scale. This method further limits the amount of coordination polymer that can be introduced into the geopolymer.

Indeed, the coordination polymer nanoparticles are only coated on the surface of the macropores of the foam and are not present in the mesoporous walls thereof, which limits the contact surface with an effluent and therefore the total capacity of the material.

Moreover, the method described in document [2] applies only to metal coordination polymer nanoparticles with CN ligands, which are not particularly suitable for selective decontamination of Sr.

Document [3] describes a solid material with multiple open and at least partially interconnected porosities, comprising a matrix made of a microporous and mesoporous geopolymer, wherein at least partially interconnected open macropores are defined, and delimited by partitions or walls made of microporous and mesoporous geopolymer, and particles of at least one solid compound that is different from the geopolymer being distributed in the macropores and/or in the partitions or walls.

This material therefore comprises macropores having sometimes thin walls and sharp junctions due to the interconnection of the porosity. These walls thus have weakened mechanical strength, particularly when an effluent passes through, which can cause the degradation thereof and the formation of fine particles liable to block a column.

Document [3] also describes the synthesis of this material. To create the macroporous network, the synthesis method involves formulating a water-in-oil emulsion comprising precursors of the material as well as removing the oil phase once the material has hardened. This greatly complicates the synthesis method and makes the material difficult to industrialize.

Document [4] describes the synthesis of a mesoporous material comprising a geopolymer and zeolite particles, obtained by a mixture of two suspensions, followed by taking the geopolymer. This document does not describe the use of this material family in column methods, nor for the extraction of Sr.

Therefore, in view of the foregoing, there is a need for a process that makes it possible to improve the performance of the fixed bed Sr decontamination processes, i.e. which makes it possible to obtain a high Sr binding capacity and a high selectivity for Sr, as well as rapid sorption kinetics and optimized column dynamics.

One of the aims of the present invention is to meet the needs for such a process, as listed above.

The aim of the present invention is furthermore to provide such a process that does not present the defects, limitations and drawbacks of the processes of the prior art, in particular of the processes described in the prior art documents cited above, and that overcomes the problems of these processes.

### DISCLOSURE OF THE INVENTION

This goal, and others, are achieved, in accordance with the invention, by a continuous process for separating at least one strontium cation, and in particular at least one cation of a radioactive isotope of strontium, such as ⁹⁰Sr, from a liquid medium containing same, in which process said liquid medium is brought into contact with a solid mesoporous material, comprising an inorganic matrix made of a mesoporous geopolymer having an open mesoporosity, and particles of at least one solid inorganic exchanger compound which is selective for the strontium cations and is distinct from the geopolymer, these particles being distributed in the open mesoporosity of the inorganic matrix and being accessible to the strontium cations contained in the liquid medium; said solid mesoporous material being in the form of non-powdery grains forming a fixed bed, for example forming a column packing.

“Non-powdery” is understood to mean that the grains obtained have a size that is large enough to not be emitted in suspension in the air, nor to be carried there.

In the description below, the particles of the at least one solid inorganic exchanger compound which is selective for the strontium cations and distinct from the geopolymer, are sometimes referred to as active particles, for the sake of simplification.

The term “particles” therefore applies to the solid inorganic exchanger compound which is selective for the strontium cations.

The inorganic matrix in a geopolymer can also be referred to as a “geopolymer binder” or “geopolymer skeleton”.

It should be noted that the term “grains” applies to the solid mesoporous material as a whole, which is a geopolymer/particle composite that constitutes the fixed bed in the form of a plurality of discrete grains such as pellets, extrutades or beads.

The process according to the invention differs from the processes according to the prior art in that it implements a specific material, a combination of a geopolymer with a specific porosity and active particles specifically selected for the purpose of selectively binding the Sr cations, distributed in the mesoporosity and accessible via the mesoporosity, making it possible to obtain a high Sr binding capacity, a high selectivity for Sr, very fast sorption kinetics and optimized column dynamics.

These capacities, selectivity and kinetics, are in any case higher than those obtained with the processes of the prior art implementing other materials.

Surprisingly, it has been demonstrated that the method according to the invention makes it possible to obtain a high strontium cation binding capacity, a high selectivity for the strontium cations and a very fast sorption kinetics of these strontium cations, as presented in the examples below. These strontium cations are in particular cations of radioactive isotopes of strontium such as ⁹⁰Sr.

The process according to the invention is carried out specifically in a fixed bed, in a column because the material it implements has the robustness and mechanical strength necessary for this and because the grain size of the material is suited to this fixed bed method.

These excellent sorption properties (kinetics, capacity, selectivity) are obtained with lower quantities of particles of a solid inorganic exchanger compound which is selective for the strontium Sr cations such as a zeolite or a crystalline silicotitanate.

The terms “geopolymer”, “matrix” or “geopolymer skeleton” used in the context of the present invention are understood to mean a solid, porous material in the dry state, obtained after the hardening of a mixture containing finely ground materials (i.e. typically an alumino-silicate source) and a saline solution (i.e. an activation solution), said mixture being capable of setting and hardening over time. This mixture can also be referred to as a “geopolymer mixture”, “geopolymer composition” or “geopolymer paste”. The hardening of the geopolymer is the result of the dissolution/polycondensation of the finely ground materials of the geopolymer mixture in a saline solution such as a high pH saline solution (i.e. the activation solution).

More particularly, a geopolymer, matrix or geopolymer skeleton is an amorphous aluminosilicate inorganic polymer. Said geopolymer is obtained from a reactive material containing essentially silica and aluminum (i.e. the alumino-silicate source), activated by a highly alkaline solution (activation solution), the solid/solution weight ratio in the formulation being low. The structure of a geopolymer is composed of a Si—O—Al network formed of silicate (SiO₄) and aluminate (AlO₄) tetrahedra joined at their apices by sharing oxygen atoms. Within this network, there are one or more charge-compensating cations, also referred to as compensation cations, that make it possible to compensate for the negative charge of the AlO₄⁻ complex. Said one or more compensation cations are advantageously selected from the group consisting of alkali metals such as lithium (Li), sodium (Na), potassium (K), rubidium (Rb) and cesium (Cs); alkaline earth metals such as magnesium (Mg), calcium (Ca), strontium (Sr) and barium (Ba); and mixtures thereof.

The term “mesoporous geopolymer” is understood to mean a geopolymer having mesopores, presenting a mesoporosity.

For the purposes of the present invention, the term “mesopores” is understood to mean pores whose average dimension, such as their diameter, measures 2 to 50 nm.

The geopolymer of the solid mesoporous material implemented in the method according to the invention has a single porosity scale, namely a mesoporosity, and does not have a hierarchized porosity like that of the geopolymer of the material described in document [3].

Since the solid mesoporous material used in the method according to the invention does not have macroporosity with thin and fragile walls, it is much more robust and mechanically resistant than, in particular, the material of document [3].

This solid mesoporous material, due to its robustness and its high mechanical resistance, can therefore be implemented in the form of non-powdery grains, i.e. grains that cannot be emitted in suspension in the air and that cannot be transported therein, forming a fixed bed, for example forming a column packing.

The solid mesoporous material used in the method according to the invention is a solid material with open mesoporosity.

The term “open mesoporosity” is understood to mean that this mesoporosity is accessible to a liquid medium such as an effluent in contact with the material. This mesoporosity is also at least partially connected (or interconnected), or even totally interconnected, i.e. the fluid can pass through the material by passing through the pores connected to each other. This mesoporosity also allows a fluid to access the active particles.

According to the invention, in addition to the mere presence of the particles of at least one solid inorganic exchanger compound which is selective for the strontium cations, it is possible to choose the nature and size of these particles virtually without any limits and independently of the geopolymer matrix.

Overall, a geopolymer skeleton has many advantages over a metal oxide skeleton.

The synthesis of a geopolymer is easier to master than the synthesis of a metal oxide by the sol-gel process.

The synthesis of a geopolymer requires cheaper precursors than those used to synthesize metal oxides (mainly alkoxides).

A geopolymer skeleton has an inherently better mechanical strength than a metal oxide skeleton also obtained by the sol-gel process.

The geopolymer skeleton of the solid mesoporous material implemented in the process according to the invention comprises mesopores, whereas a metal oxide skeleton does not. To create mesoporosity in a metal oxide, an additional compound must be added to the formulation, thus complicating the system.

Finally, the solid mesoporous material implemented in the process according to the invention has a mesoporosity, is mechanically robust and integrates particles of at least one solid inorganic exchanger compound which is selective for the strontium cations, for a specific fixed bed, column application.

The material implemented in the process according to the invention ensures improved accessibility of the Sr cations contained in the liquid medium, such as an effluent to be treated, to the particles distributed in the material, due in particular to the interconnectivity that exists between the mesopores.

Grains of the solid mesoporous material are non-powdery grains such as grains, seeds, pellets, extrudates, beads, or balls with a typical average size, such as a diameter, of 100 μm to 5 mm, preferably from 300 μm to 5 mm, even more preferably from 300 μm to 500 μm. These grains of solid mesoporous material form a fixed bed, for example a column packing.

Grains which generally have the size as specified above, can indeed be qualified as non-powdery, because this size does not define a powder, which can be defined as having a size strictly less than 100 μm. These non-powdery particles thus avoid clogging risks when used in fixed beds, in columns, and limit head losses.

Advantageously, grains with an average size of 300 μm to 5 mm, and preferably from 300 μm to 500 μm, are particularly well suited for implementation in a fixed bed to pack a column.

The term “size” is used to typically refer to the largest dimension, such as the diameter, of the solid mesoporous material particles.

Advantageously, the particles of the at least one solid inorganic exchanger compound which is selective for the strontium cations and different from the geopolymer, can be selected from the group consisting of nanometric particles (typically defined by their diameter of 2 to 100 nm), submicron particles (typically defined by their diameter of 100 nm to 1 μm) and micron particles (typically defined by their diameter of 1 to 10 μm) and can in particular have an average size, such as a diameter, from 2 nm to 50 μm, preferably from 10 nm to 10 μm, and more preferably from 20 nm to 1 μm.

The term “size” here also means the largest dimension, such as the diameter, of the particles of the at least one solid inorganic exchanger compound which is selective for the strontium cations and different from the geopolymer.

Advantageously, the active particles of the at least one solid inorganic exchanger compound which is selective for the strontium cations have a ball, bead, sphere or spheroid shape, or even a needle shape.

The particles of the at least one solid inorganic exchanger compound which is selective for the strontium cations and different from the geopolymer, are preferably inorganic, mineral particles, i.e. particles constituted solely (100%) by one or more inorganic, mineral solid compounds.

Such 100% inorganic, mineral particles are particularly advantageous in the context of the treatment of radioactive effluents, due to their compatibility with nuclear waste management channels.

The material according to the invention, which comprises such active, 100% mineral particles, and the geopolymer, which is itself 100% mineral, is then also 100% mineral, which therefore makes it fully compatible with nuclear waste management channels.

Advantageously, the solid inorganic, mineral, exchanger compound which is selective for the strontium cations and different from the geopolymer, can be selected from the group consisting of zeolites; alkaline silicotitanates, such as sodium silicotitanate; and mixtures thereof.

The solid inorganic, mineral, exchanger compound which is selective for the strontium cations can be selected based on the properties of the liquid, such as an effluent, and of the contaminant to be extracted that it is intended to treat, such as salinity and pH.

This solid inorganic exchanger compound which is selective for the strontium cations can be, for example, an ion exchanger based on sodium silicotitanate in the case where the effluent also contains calcium (Ca) cations in order to minimize competition between the Sr cations and the Ca cations, or an ion exchanger based on LTA zeolite in the case where the effluent also contains sodium (Na) cations in order to minimize competition between the Sr cations and the Na cations.

There is no limitation on the form of the active particles of at least one solid compound that is different from the geopolymer.

Advantageously, the particle content of the at least one solid inorganic exchanger compound which is selective for the strontium cations and different from the geopolymer is from 0.05 to 70% by weight, preferably from 10 to 40% by weight, of the total weight of the solid mesoporous material.

Advantageously, after having brought the liquid medium into contact in a fixed bed with the solid mesoporous material, the used fixed bed containing the strontium cations fixed on the particles is directly transformed into a conditioning material. This conditioning material can advantageously be obtained by blocking the grains of the solid mesoporous material directly within the fixed bed by incorporating therein a binder, for example a geopolymer or cementitious binder, making it possible to form a dense monolithic material incorporating the grains of mesoporous materials.

In summary, the material implemented in the process according to the invention:
has a high capacity and selectivity for Sr as well as fast sorption kinetics, and dynamics optimized for a column method. This reduces the processing time, ensures sustained processing rates, and limits the size of the columns used and therefore the volume of waste generated by the treatment process.
can easily be put into a form suitable for use in a packed column without there being significant head losses throughout the treatment plant.
can, in general, be easily prepared by a method that is easy to implement and easily transposable to an industrial scale.
has great versatility in terms of composition and shaping geometry that makes it possible to adapt the material to any type of effluent and to any type of fixed bed, column method.
typically has a chemical nature compatible with the waste management sectors specific to the nuclear sector.

The solid mesoporous material implemented in the process according to the invention, as just described, can be prepared by the method described below.

This method for preparing the solid mesoporous material can comprise at least the following successive steps:
a) mixing a first aqueous suspension of particles of at least one solid inorganic exchanger compound which is selective for the strontium cations, in water or in an aqueous solution comprising a surfactant, with an aqueous activation solution and an aluminosilicate source capable of forming the geopolymer by dissolution/polycondensation, whereby obtaining a second aqueous suspension;
b) the second aqueous suspension is allowed to rest, and the geopolymer skeleton is formed by polycondensation, whereby the open solid mesoporous material is obtained, comprising a skeleton made of a mesoporous geopolymer, having an open mesoporosity, and particles of at least one solid inorganic exchanger compound which is selective for the strontium cations and distinct from the geopolymer, being distributed in the mesoporosity and accessible via the mesoporosity.

Advantageously, step a) comprises the following successive steps a1), a2) and a3):
a1) preparing a first aqueous suspension of particles of at least one solid inorganic exchanger compound which is selective for the strontium cations, in water or in an aqueous solution comprising a surfactant;
a2) adding an aqueous activation solution to the first aqueous suspension of particles of at least one solid inorganic exchanger compound which is selective for the strontium cations obtained at the end of step a1), whereby an aqueous suspension a2 is obtained;
a3) adding an aluminosilicate source capable of forming the geopolymer by dissolution/polycondensation, to the aqueous suspension a2, whereby said second aqueous suspension is obtained.

The particle concentration in the second suspension is chosen according to the final particle concentration of at least one solid inorganic exchanger compound which is selective for the strontium cations and different from the geopolymer, that is desired in the prepared material.

Advantageously, at the end of step a2) and before step a3), the suspension a2 is homogenized, for example by mechanical stirring.

Advantageously, at the end of step a3) and before step b), the second suspension is homogenized, for example by mechanical stirring.

The term “mechanical stirring” is typically understood to mean mechanical stirring which uses a stirring device equipped with a blade rod or, preferably, a homogenizing or dispersing device (e.g. of the Ultra-Turrax, IKA® type) which can be equipped with a dispersing rod having a rotor/stator system.

Advantageously, during step b), the second aqueous solution is allowed to rest, so that the geopolymer skeleton can be formed by polycondensation in the second aqueous suspension, and it is shaped and formed to obtain a chosen size and shape.

This preparation method is very simple because the solid mesoporous material is prepared by simply adding the active solid particles during the synthesis of the geopolymer.

This preparation method is considerably simpler and therefore more reproducible, less time-consuming and less costly than methods that require the preparation of an oil-in-water emulsion.

This preparation method allows for the synthesis of the material implemented in the process according to the invention, i.e. a material with mesoporosity, that is mechanically robust and integrating active particles with improved accessibility of the active particles to the liquid medium, such as an effluent to be treated.

The terms “aluminosilicate source” and “reactive material containing essentially silica and aluminum” are, in the present invention, similar and can be used interchangeably.

The reactive material containing essentially silica and aluminum that can be used to prepare the geopolymer skeleton of the solid mesoporous material is advantageously a solid source containing amorphous aluminosilicates, known in the prior art for the preparation of a geopolymer, such as kaolinite or metakaolin.

The term “activation solution” is understood to mean the high pH saline solution well known in the field of geopolymerization. The latter is a highly alkaline aqueous solution which can possibly contain silicated components particularly selected from the group consisting of silica, colloidal silica and vitreous silica.

The terms “activation solution”, “high pH saline solution” and “highly alkaline solution” are similar and can be used interchangeably herein.

The terms “highly alkaline” or “high pH” are understood to mean a solution whose pH is greater than 9, in particular greater than 10, in particular greater than 11 and, more particularly greater than 12.

The activation solution comprises the compensation cation or the mixture of compensation cations that was/were defined above in the form of an ionic solution or a salt. Thus, the activation solution is in particular chosen from an aqueous solution of sodium silicate (Na₂SiO₃), potassium silicate (K₂SiO₂), sodium hydroxide (NaOH), potassium hydroxide (KOH), calcium hydroxide (Ca(OH)₂), cesium hydroxide (CsOH) and derivatives thereof, etc.

In summary, the advantages of this method for preparing the solid mesoporous material implemented in the process according to the invention, namely a mesoporous material comprising active particles are, among others, that:
the nature of the sites selective for the Sr corresponds directly to the nature of the active particles integrated in the formulation of the solid mesoporous material (nanometer, submicron or micron particles),
this preparation method is carried out under mild conditions, at low temperatures, typically at ambient temperature and atmospheric pressure,
this preparation method implements commercially available, inexpensive and non-toxic reagents, in particular for the activation solution and the aluminosilicate source, with the reaction media being essentially aqueous.

In this respect, this preparation method, unlike methods involving an oil-in-water emulsion, does not use organic solvents but only aqueous phases and is therefore environmentally friendly and cos-effective.
this preparation method is simple, reliable, and easy to implement. It can be carried out using a simple facility and simple equipment. In particular, this preparation method can be a method of which all the steps can be carried out in a single reactor.

According to a first embodiment, when the solid material with an open mesoporosity obtained at the end of step b) is in the form of a monolith, then, at the end of step b), the following successive steps c), d), e) and f) are carried out:
c) grinding the monolith to obtain grains;
d) sieving the grains obtained at the end of step c) to obtain non-powdery particles such as grains, seeds, pellets, beads, or balls having a determined average size; preferably an average size, such as a diameter, from 100 μm to 5 mm, more preferably from 300 μm to 5 mm;
e) washing the non-powdery particles obtained at the end of step d);
f) drying the non-powdery particles.

Step c) is a coarse grinding step, i.e. a step which does not seek to control the particle size of the grains obtained, which is therefore very large.

Step d) is carried out so as to obtain non-powdery grains with a particle size, a size distribution desired for the intended use of the material, for example an average size of is 300 μm to 5 mm, which is the most suitable particle size for use in a column treatment method.

Step e) is necessary to remove the fine particles that adhere to the grains following grinding (these fine particles are indeed likely to clog the column) as well as to remove the surplus cations resulting from the geopolymerization.

One or more washes can be performed, for example with demineralized water.

Step f) can be performed at a temperature of 30 °C to 90 °C, for a duration of 1 to 48 hours.

According to a second embodiment, in step b), the second aqueous suspension is extruded to form extrudates having a determined, controlled shape and size, which can be selected with regard to the method in which the extrudates of solid mesoporous material are used.

According to a third embodiment, the second aqueous suspension can be atomized to form balls or beads of solid mesoporous material, the size of which is determined depending on the application according to the process of the invention.

The process according to the invention can be used in particular in nuclear decontamination and depollution of liquid effluents by fixed-bed ion exchange, in a column, with the material being in granular form.

Advantageously, said liquid medium can be an aqueous liquid medium, such as an aqueous solution.

Said liquid medium can be a process liquid or an industrial effluent.

Advantageously, said liquid medium can be chosen from liquids and effluents from the nuclear industry and facilities and activities implementing radionuclides.

Typically, the Sr cation can be present at a concentration from 0.1 picogram to 500 mg/L, preferably from 0.1 picogram to 100 mg/L.

Zeolites as well as silicotitanates are particularly well suited for the separation of Sr.

Upon completion of the implementation of the separation process of the invention, in particular in the case where the treated liquid medium is a radioactive effluent, the material in the form of grains forming a fixed bed, for example forming a column packing can be densified by adding a suspension of precursors of the geopolymer in the used column.

The invention will now be described in more detail below, specifically in connection with particular embodiments thereof, for which examples are in particular given.

This description is provided for illustrative and non-limiting purposes, and with reference to the accompanying drawings.

### BRIEF DESCRIPTION OF THE DRAWINGS

FIG. 1 is a photograph of the Geopo-Zeo-27 grains (300-500 μm) of a selective geopolymer-adsorbent composite material obtained in Example 1.

FIG. 2A shows the diffractograms obtained for the “Geopo-Zeo” materials comprising a geopolymer and LTA zeolite which were prepared in Example 1, as well as that of the “Geopo-0” material and LTA zeolite powder. 2θ (in °) is shown on the x-axis and the intensity (in arbitrary units) on the y-axis.

FIG. 2B shows the diffractograms obtained for the “Geopo-CST” materials comprising a geopolymer and the crystalline silicotitanate CST of Na, which were prepared in Example 1, as well as that of the material “Geopo-O” and the silicotitanate CST of Na powder (“CST powder”). 2θ (in °) is shown on the x-axis. The intensity (in arbitrary units) is shown on the y-axis.

FIG. 3A shows the pore size distributions in the materials “Geopo-0” corresponding to the pure geopolymer and “Geopo-Zeo” comprising a geopolymer and the LTA zeolite which were prepared in Example 1. The pore diameter (in nm) is shown on the x-axis and dV(r) (in cm³/nm/g) is shown on the y-axis.

FIG. 3B shows the pore size distributions in “Geopo-CST” materials comprising a is geopolymer and crystalline silicotitanate CST of Na, which were prepared in Example 1 as well as the pore size distribution in the “Geopo-0” material. The pore diameter (in nm) is shown on the x-axis and dV(r) (in cm³/nm/g) is shown on the y-axis.

FIG. 4 shows the change in the maximum sorption capacity of the materials prepared in Example 1, as a function of their weight percentage in zeolite (“-zeo”) or silicotitanate (“-CST”), and also shows the maximum sorption capacity of the geopolymer alone (“geopo”) (see Example 3). The squares ▪ correspond to the geopolymer alone (“geopo”), the circles ● correspond to the materials “Geopo-Zeo” comprising a geopolymer and the LTA zeolite, and the triangles [symbol] correspond to the materials “Geopo-CST” comprising a geopolymer and the crystalline siliotitanate CST of Na. The weight percentage of the adsorbent (zeolite or silicotitanate) is shown on the x-axis and Q (in mg·g⁻¹) is shown on the y-axis.

FIG. 5 shows the change in the distribution coefficient KD of the materials prepared with respect to strontium as a function of their weight percentage of adsorbent (zeolite or silicotitanate), and also shows the distribution coefficient KD of the geopolymer alone (see Example 3). The square ▪ corresponds to the geopolymer alone (“geopo”), the circles ● correspond to the materials “Geopo-Zeo” comprising a geopolymer and the LTA zeolite, and the triangles [symbol] correspond to the materials “Geopo-CST” comprising a geopolymer and the crystalline silicotitanate CST of Na. The weight percentage of the adsorbent (zeolite or silicotitanate) is shown on the x-axis and the distribution coefficient KD with respect to Sr (in mL/g) is shown on the y-axis.

FIG. 6 shows the evolution of the sorption capacity of Sr as a function of the contact time between the material and the solution, for the “Geopo-Zeo-27” material prepared in example 1, and for the geopolymer alone, namely the “Geopo-0” material. The squares ▪ correspond to the geopolymer, and the triangles [symbol] correspond to the “Geopo-Zeo-27” materials comprising a geopolymer and the LTA zeolite. The contact time (in minutes) is shown on the x-axis, and the sorption capacity of Sr, Q (in mg·g⁻¹), is shown on the y-axis.

FIG. 7 shows the evolution of the distribution coefficient of the Geopo-0 and Geopo-Zeo-27 materials as a function of the concentration of Sr at equilibrium in the solution. In other words, FIG. 7 shows the sorption isotherms produced for the Geopo-0 and Geopo-Zeo-27 materials in a saline matrix (see Example 3). The squares ▪ correspond to the geopolymer, and the triangles [symbol] correspond to the “Geopo-Zeo-27” materials comprising a geopolymer and the LTA zeolite. The concentration of Sr at equilibrium in the solution: [Sr]fin (in mg·L⁻¹) is shown on the x-axis, and the distribution coefficient KD with respect to Sr (in mL·g⁻¹) is shown on the y-axis.

FIG. 8 shows the breakthrough curves of the materials “Geopo-Zeo 27”; “Geopo-CST-5” and “Geopo-CST-10”, prepared in Example 1, i.e. the change in the concentration of Sr ([Sr]) (normalized by the initial concentration of Sr ([Sr]0) as a function of the volume of effluent having passed through the column (see Example 4). The squares ▪ correspond to the material “Geopo-Zeo-27”, the circles ● correspond to the material “Geopo-CST-5” and the triangles [symbol] correspond to the material “Geopo-CST-10”. The volume of effluent having passed through the column is shown on the x-axis (in mL), and [Sr]/[Sr]₀ is shown on the y-axis.

### DETAILED DISCLOSURE OF THE INVENTION

The description below firstly describes one particular embodiment of the method for preparing the material implemented in the process according to the invention.

One particular embodiment of the process according to the invention is then described, wherein this material is used to separate Sr cations from a liquid medium containing same.

In this particular embodiment of the method for preparing the material, the solid particles are particles of at least one solid inorganic exchanger compound which is selective for the strontium cations. This particular embodiment of the method for preparing the material implemented in the process according to the invention and then of the separation process according to the invention implementing same comprises the following steps:
(1) selecting the selective Sr-ion exchanger according to the properties of the effluent to be treated, such as salinity or pH. For example, a sodium silicotitanate ion exchanger will be preferred in the case of competitive adsorption conditions between Sr and Ca or a LTA zeolite ion exchanger in the case of competitive conditions with Na;
(2) synthesizing the ion exchanger (or use of a commercial product) selected in an ideal form for incorporation into the geopolymer while maintaining good extraction kinetics. Thus, particles of submicron size will preferably be chosen;
(3) adapting the composition of the geopolymer so that it has a high mechanical strength, a mesoporous network, and good compatibility with the ion exchanger. Parameters such as, for example, the alkali used (K⁺, Na⁺, etc.), the value of the Si/Al ratio or the amount of water added in the formulation will be of particular interest;
(4) synthesizing the cation exchanger-geopolymer composite by simply adding the cation exchanger during the synthesis of the geopolymer;
(5) shaping the material according to a path adapted to the constraints of the decontamination method: coarse grinding of the composite and sieving to select the particle size best suited to the column methods (generally centered on 300 μm-5 mm), synthesis of beads or extrudates, etc.
(6) washing the material to remove the presence of fine particles that can clog the column and removing excess cations from the geopolymerization;
(7) filling a column with the material formed;
(8) percolating the column using the effluent containing the radioactive Sr to be extracted;
(9) drying the column by an air flow then sending the column to the vents;
(10) optionally, directly densifying the used column by adding a solution of geopolymer precursors.

The invention will now be described with reference to the following examples, which are given for illustration purposes and not intended to limit the scope of the invention.

### EXAMPLES

### Example 1: Synthesis of Composite Materials Used in the Method According to the Invention and of a Reference Material

This example describes the synthesis of grains of “selective adsorbent-geopolymer” composite materials implemented in the process according to the invention, is which enable efficient and selective decontamination of Sr in aqueous effluents both in a batch process and in a continuous process in a column packed with these grains.

Firstly, two ion exchanger adsorbents selective for the Sr are chosen:
an LTA zeolite with increased selectivity for Na.
a crystalline silicotitanate (CST) of Na, which is an even more selective adsorbent for Sr than LTA zeolite.

In addition to their increased selectivity for Sr, these two adsorbents were also selected because their microstructural properties are compatible with the intended application:
their size is small enough to have rapid sorption kinetics (of the order of a few hundred nm/a few microns). More specifically, the average particle size of LTA zeolite is 200 to 500 nm, and the average particle size of CST is less than 100 nm.
they are completely mineral, which gives them good radiation resistance;
they are resistant to highly basic media, which allows them to be integrated into “geopolymer” type matrices.

The composition of the geopolymer has been optimized to cause a mesoporous geopolymer binder to be produced, which makes the selective adsorbent accessible to the effluent to be treated and mechanically strong enough not to crumble during the decontamination process.

The “selective adsorbent-geopolymer” composite materials synthesis protocol implemented in this example is as follows:
Step 1: a predefined amount of submicron powder of selective adsorbent (either LTA zeolite or CST) is added to 1.77 mL of water and placed for 15 minutes in an ultrasonic bath. The quantities of adsorbent used were calculated so that the particles could represent between 5 and 27% by weight of the final material. These quantities are as follows: 0.420 g adsorbent for 5% by weight, 0.887 g adsorbent for 10% by weight, 1.995 g adsorbent for 20% by weight and 2.952 g adsorbent for 27% by weight.
Step 2: 2.12 mL of a solution composed of 81% by weight of a commercial inorganic is binder called Betol® K5020T (available from Wöllner®), based on an aqueous solution of modified potassium silicate, and composed of 30% by weight of SiO₂, 18% by weight of K₂O, and 52% by weight of H₂O; and of 19% by weight of KOH (at 85%, marketed by Sigma-Aldrich®) is added to the suspension obtained at the end of step 1.

The suspension is then homogenized manually.
Step 3: 2.64 g of clay powder, namely Metakaolin (Metamax® from BASF) is added to the suspension obtained at the end of step 2.

The suspension obtained is then homogenized again manually or using an Ultra-Turrax® homogenizer equipped with an S25N-18G dispersing head at a shear rate between 3000 and 5000 rpm.

After 48 hours of rest at room temperature, a robust monolithic material is obtained.
Step 4: The monolithic material is ground, then the resulting grains of material are sieved to ultimately obtain grains with a size distribution between 300 and 500 μm.
Step 5: A washing step is carried out.

To do this, 3 g of the grains of the material are stirred manually for 30 seconds in the presence of 100 mL of demineralized water. This step is repeated 4 times, with the water being changed between each test.
Step 6: The grains of material are ultimately dried at 80 °C for approximately 12 hours.

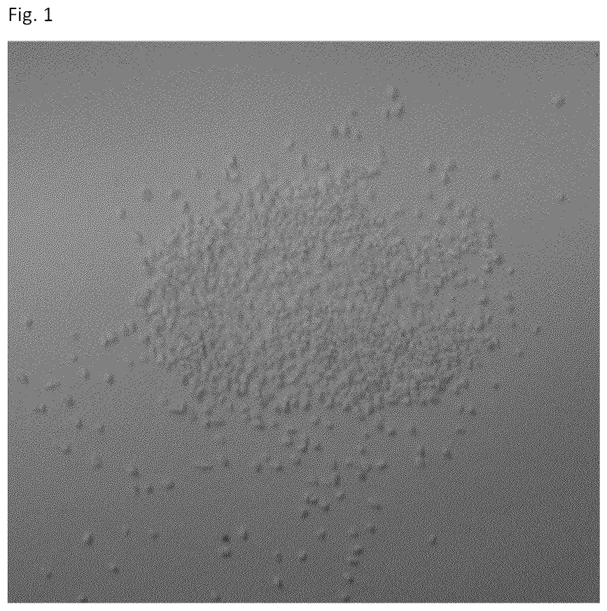

FIG. 1 is a photograph of the grains (300-500 μm) of a selective adsorbent-geopolymer composite material obtained at the end of the synthesis described above, called Geopo-Zeo-27.

It can therefore be noted that the method for preparing the materials used in the process according to the invention requires only simple steps and is easily transposable on an industrial scale.

By way of comparison, a so-called reference material, consisting only of the geopolymer and not containing active particles of adsorbent, in particular neither zeolite nor silicotitanate, is also prepared in this example. This material is prepared by a method comprising only steps 2, 3, 4, as well as 5 and 6.

The prepared materials are named according to the percentage of adsorbent in the material. Table 1 summarizes the materials prepared in Example 1 and their names.

TABLE 1

| % by weight of adsorbent | Geopolymer - | Geopolymer - |
|---|---|---|
| in the material | LTA Zeolite | Silicotitanate |
| 0 | Geopo-0 | Geopo-0 |
| 5 | Geopo-Zeo-5 | Geopo-CST-5 |
| 10 | Geopo-Zeo-10 | Geopo-CST-10 |
| 20 | Geopo-Zeo-20 | Geopo-CST-20 |
| 27 | Geo-Zeo-27 | Geopo-CST-27 |

The composite materials used in the process according to the invention, and prepared in Example 1, are characterized and used in the following Examples 2, 3, and 4.

### Example 2: Characterization of the Materials Prepared in Example 1

In this example, the composite materials implemented in the method according to the invention synthesized in Example 1 and the reference material are characterized on the one hand by X-ray diffraction to verify that the selective mineral exchangers are not degraded during synthesis; and on the other hand by nitrogen adsorption-desorption to verify the presence of mesopores in the geopolymer binder.

The presence of mesopores in the geopolymer binder allows the mineral exchangers to be accessible to the effluent to be treated.

### X-Ray Diffraction Analysis of the Materials.

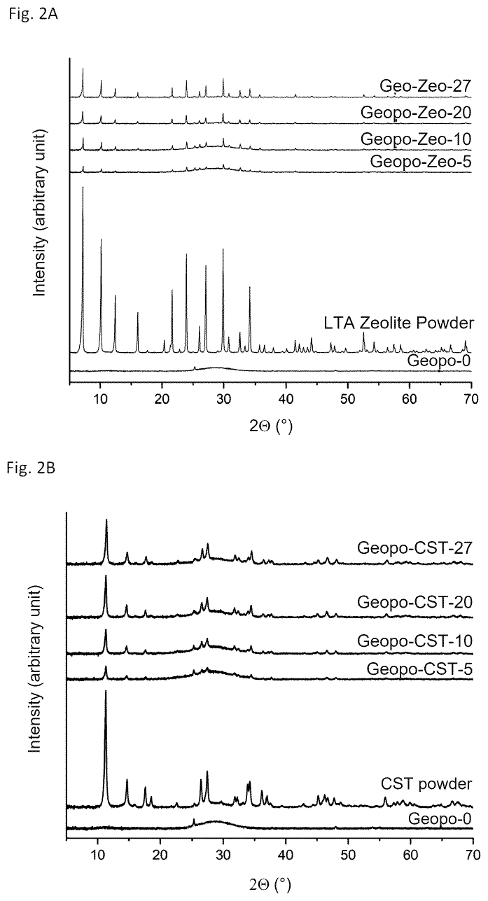

FIGS. 2A and 2B show the diffractograms obtained for the materials described in Example 1.

FIG. 2A shows the diffractograms obtained for the “Geopo-Zeo” materials comprising a geopolymer and a zeolite.

FIG. 2B shows the diffractograms obtained for the “Geopo-CST” materials comprising a geopolymer and a silicotitanate.

These figures show that the LTA zeolite and silicotitanate CST particles were well integrated into the composite material without suffering any degradation to their crystalline structure. Thus, the crystalline structures responsible for the affinity of the materials for Sr are well preserved.

### Analysis of the Materials by Nitrogen Adsorption-Desorption.

The different materials prepared in Example 1 are analyzed by nitrogen adsorption-desorption.

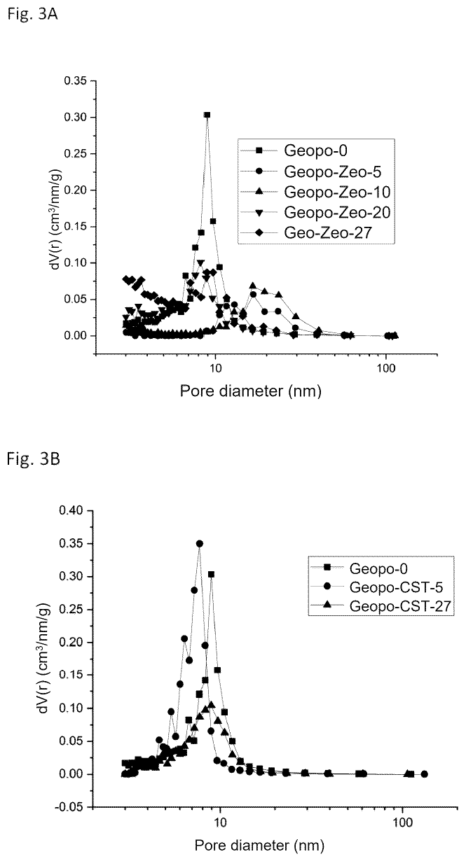

FIG. 3A shows the pore size distributions in the “Geopo-Zeo” materials comprising a geopolymer and a zeolite, obtained by the “BJH” method (Barrett, Joyner, Halenda model).

FIG. 3B shows the pore size distributions in the “Geopo-CST” materials comprising a geopolymer and a silicotitanate, obtained by the “BJH” method (Barrett, Joyner, Halenda model).

It can be seen that the synthesized materials are all mesoporous with pore size distributions as a whole centered between 4 and 40 nm. Since the zeolite and silicotitanate selective adsorbents are not mesoporous, it is the mesopores of the geopolymer binder that are detected.

Thus, the selective adsorbents dispersed in the geopolymer binder are accessible to the ions of interest to be fixed (the Sr in the case of these examples) after the shaping step, via the mesopores of the geopolymer.

It should be noted that the presence of selective adsorbent particles in the formulation of the materials somewhat alters the size of the mesopores. However, this point is not problematic because the size of the measured mesopores is systematically large enough to allow rapid diffusion of an ion.

Thus, the synthesized materials have crystalline sites, crystalline zones, made up of the zeolite and silicotitanate selective adsorbents which will allow the material to be more selective for Sr, and a mesoporous network which will allow the ions to access these crystalline sites as well as rapid sorption kinetics.

### Example 3: Sorption Performance, in Batch Mode, of the Materials Prepared in Example 1

In this example, tests are performed to evaluate the sorption performance, in batch mode, of the materials prepared in Example 1.

In a first step, a study of the sorption capacities and selectivity of the materials is carried out. The objective of these tests is to observe the influence of the presence of selective adsorbents (zeolite and silicotitanate) in the formulation of the materials, in particular on their capacity Q (mg·g⁻¹) and their selectivity, expressed as a function of the selectivity coefficient KD (mL·g⁻¹), with respect to strontium.

In order to estimate the maximum sorption capacity of the materials, the sorption tests are carried out in a solution highly concentrated in Sr.

The protocol for these sorption tests in order to estimate the maximum sorption capacity of the materials is as follows:
50 mg of material in the form of 300-500 μm grains is placed in 50 mL of a highly saline aqueous matrix (deionized water) comprising 0.25 mol/L of NaNO₃, 50 ppm of Ca (Ca(NO₃)₂ salt) and 200 ppm of Sr (Sr(NO₃)₂ salt).
it is stirred with the rotary stirrer for 24 h.
after stirring, 15 ml of supernatant is taken with a syringe and filtered with a 0.22 μm syringe filter, then the residual Sr concentration of the sampled and filtered solution is analyzed.

The value of the extraction or sorption capacity Q of Sr (quantity of Sr captured per gram of material) is then determined as follows:

$$Q = ( {[ Sr ]}_{init} - {[ Sr ]}_{fin} ) \frac{V}{m}$$

where [Sr]ᵢₙᵢₜ and [Sr]_{fin} represent respectively the initial Sr concentration and the final Sr concentration in solution (mg·L⁻¹), V is the volume of solution (ml), and m is the weight of material (g).

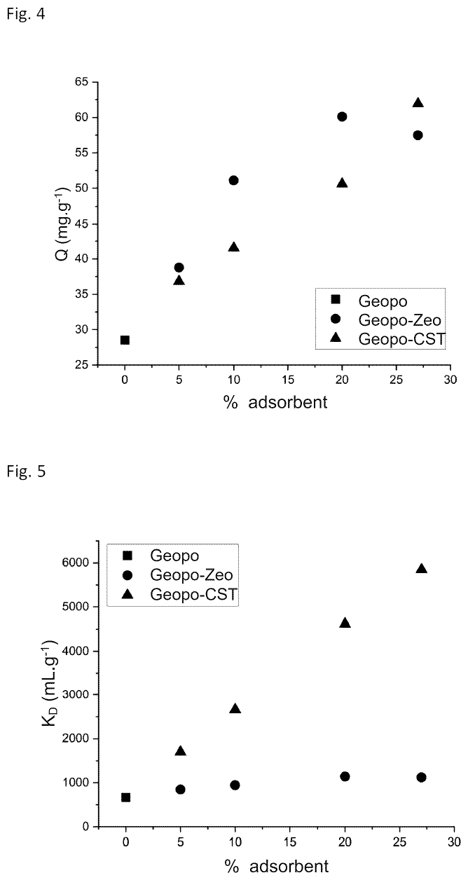

FIG. 4 shows the change in the maximum sorption capacity of the materials as a function of their weight percentage of adsorbent.

It can be seen that, regardless of the adsorbent used, the sorption capacity of the material increases with the concentration of adsorbent, thus demonstrating the interest of is the presence of this adsorbent in the material, as well as the accessibility of the adsorbents to the treated solution thanks to the mesoporosity of the geopolymer.

In order to estimate the value of the distribution coefficient of the materials (the ratio between the quantity of Sr captured by the material and the quantity of Sr remaining in the solution), the sorption tests are carried out in a solution with a low Sr concentration.

The protocol for these sorption tests in order to estimate the value of the distribution coefficient of the materials is as follows:
50 mg of material in the form of 300-500 μm grains is placed in 50 ml of a highly saline aqueous matrix (deionized water) comprising 0.25 mol/L of NaNO₃, 50 ppm of Ca (Ca(NO₃)₂ salt) and 200 ppm of Sr (Sr(NO₃)₂ salt).
it is stirred with the rotary stirrer for 24 h.
after stirring, 15 ml of supernatant is taken with a syringe and filtered with a 0.22 μm syringe filter, then the residual Sr concentration of the sampled and filtered solution is analyzed.

The value of the distribution coefficient K_{D} with respect to Sr is then determined as follows:

$${K}_{D} = \frac{( {[ Sr ]}_{init} - {[ Sr ]}_{fin} )}{{[ Sr ]}_{fin}} \frac{V}{m}$$

where [Sr]ᵢₙᵢₜ and [Sr]_{fin} represent respectively the initial Sr concentration and the final Sr concentration in solution (mg/L), V is the volume of solution (mL), and m is the weight of material (g).

FIG. 5 shows the change in the distribution coefficient K₀ of the materials as a function of their weight percentage of adsorbent.

It can be seen that, regardless of the adsorbent used, the distribution coefficient of the composite material with respect to Sr increases with the concentration of adsorbent, thus demonstrating the interest of the presence of the adsorbent in the material.

However, the influence of the two adsorbents is different. The presence of 27% by weight of LTA zeolite in the material increases the K_{D}, which is 667 mL·g⁻¹ for the pure geopolymer, to 1120 mL·g⁻¹, whereas for the same CST concentration, the K_{D} increases to 5648 mL·g⁻¹.

It should be noted that these values were obtained with an initial Sr concentration of 2 ppm. It will be demonstrated hereinbelow that this value of K₀ increases for lower initial Sr concentrations.

This difference can be explained by the composition of the solution in which the tests are carried out and in particular the concentrations of Na and Ca and the nature of the adsorbents used. Indeed, CST is more selective for Sr compared to Ca and Na than LTA zeolite.

Further studies in batch mode were then carried out on two materials, namely the following: Geopo-0 and Geopo-Zeo-27.

These studies are a kinetic study and a complete isothermal study.

### Kinetic Study

The sorption kinetics of the materials can be characterized by analyzing the sorption of the materials as a function of the contact time between the materials and the effluent to be treated.

The protocol for these tests to study the sorption kinetics of the materials is as follows:
50 mg of material in the form of 300-500 μm grains is placed in 50 mL of a highly saline aqueous matrix comprising 0.25 mol/L of NaNO₃, 50 ppm of Ca (Ca(NO₃)₂ salt) and 50 ppm of Sr (Sr(NO₃)₂ salt).
several batches are prepared and left under rotary stirring for different durations varying between 5 minutes and 48 hours.
after stirring, 15 ml of supernatant is taken with a syringe and filtered with a 0.22 μm syringe filter, then the residual Sr concentration of the sampled and filtered solution is analyzed.

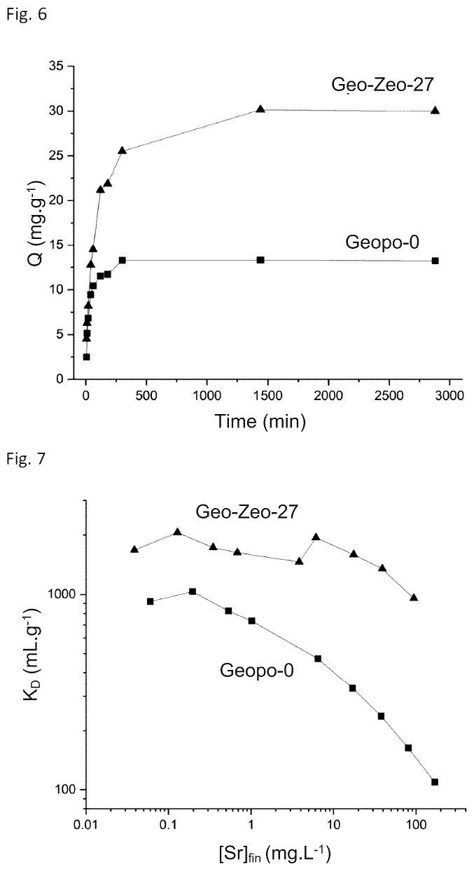

FIG. 6 shows the change in the sorption capacity of Sr for the two materials studied is (Geopo-27 and Geopo-0) as a function of the contact time between the material and the solution.

Thus, it was shown in this example that the process according to the invention, which implements pellet materials, and is therefore usable in a column, ensures rapid sorption kinetics (equilibriums reached in less than 24 hours) due to the mesoporosity of the geopolymer binder which makes the ions easily accessible to the selective adsorbent particles.

### Complete Isothermal Study

The purpose of these tests is to determine the value of the distribution coefficient at very low Sr concentrations, which are the most representative of the Sr concentrations found in radioactive effluents.

The protocol for these tests aimed at establishing the sorption isotherms is as follows:
50 mg of material in the form of 300-500 μm grains is placed in various batches comprising 50 mL of a highly saline aqueous matrix (deionized water) comprising 0.25 mol/L⁻¹ of NaNO₃, 50 ppm of Ca (Ca(NO₃)₂ salt), with different Sr concentrations (Sr(NO₃)₂ salt) of between 0.1 and 200 mg·L⁻¹.
the batches are left under rotating stirring for 24 hours.
after stirring, 15 ml of supernatant is taken with a syringe and filtered with a 0.22 μm syringe filter, then the residual Sr concentration of the sampled and filtered solution is analyzed.

FIG. 7 shows the evolution of the distribution coefficient of the materials as a function of the Sr concentration in equilibrium in the solution.

In other words, FIG. 7 shows the sorption isotherms produced for the Geopo-0 and Geopo-Zeo-27 materials in a saline matrix.

The most representative distribution coefficient of radioactive effluents is at the level of the plateau obtained at the lowest Sr concentrations. Thus, a significant influence of the presence of selective adsorbents in the material can be seen on the selectivity of this material for Sr. In the matrix considered (0.25 mol/L NaNO₃ and 50 ppm Ca (Ca(NO₃)₂ salt), the K_{D} of the Geopo-0 material is around 1030 mL·g⁻¹, while it reaches 2044 mL·g⁻¹ for Geopo-Zeo-27.

In conclusion, the mesoporous and multiphase microstructure of the materials used in the process of the present invention makes it possible to:
firstly, shape into pellets that can be used in a column while maintaining rapid sorption kinetics
secondly, improve the selectivity of the material for Sr.

### Example 4: Material Performance in a Fixed Bed Decontamination Process

In this example, the composite granular materials implemented in the process according to the invention, and described in Example 1, are tested in a column in order to demonstrate the interest of their microstructure in their performance in a decontamination process according to the invention, in a fixed bed.

The tests were carried out according to the following protocol:
the grains sieved at 300-500 μm are placed in a glass column with a height H=3 cm and a diameter D=1 cm.
the column is placed in an assembly consisting of an effluent reservoir, a peristaltic pump, and a pressure gauge at the head of the column to measure the head losses.

Using this assembly, breakthrough curves (defined below) were produced.

An aqueous effluent (deionized water), comprising 0.25 mol·L⁻¹ of NaNO₃, 50 ppm of Ca (Ca(NO₃)₂ salt) and 100 ppm of Sr (Sr(NO₃)₂ salt) flows through the packed column at a flow rate of 20 mL·h⁻¹ and the breakthrough curve is obtained by measuring, by ICP-OES, the Sr concentration in the samples taken at the outlet over time.

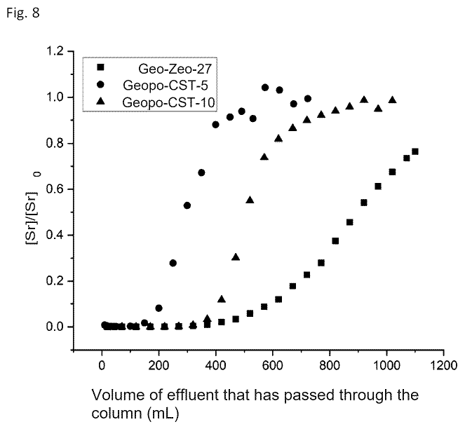

FIG. 8 shows the breakthrough curves of the materials Geopo-Zeo 27; Geopo-CST-5 and Geopo-CST-10, i.e. the change in the Sr concentration (normalized by the initial Sr concentration) as a function of the volume of effluent having passed through the column.

This figure shows that the breakthrough curves are in the form of sigmoids with vertical slopes, and are completely in line with what could be expected, which demonstrates ideal behavior in a column method.

The higher the amount of adsorbents, the higher the volume that can be treated is with the same amount of material, and the slope of the curve is vertical.

### REFERENCES

[1] WO-A1-2018/015490.
[2] WO-A1-2016/173950.
[3] WO-A1-2021/152248.
[4] PAPA ET AL, “Zeolite-geopolymer composite material: Production and characterization”. Journal of Cleaner Production, 17 (2018) 76-84.

1. A method for separating at least one strontium cation from a liquid medium containing the same, the method comprising:
contacting the liquid medium with a solid mesoporous material,
wherein the solid mesoporous material comprises:
an inorganic matrix made of a mesoporous geopolymer having an open mesoporosity and a single porosity scale; and
particles of at least one solid inorganic exchanger compound which is selective for the strontium cations and is distinct from the geopolymer,
wherein the particles distributed in the open mesoporosity of the inorganic matrix and are accessible to the strontium cations contained in the liquid medium, and
the solid mesoporous material is in the form of non-powdery grains forming a fixed bed.

2. The method of claim 1, wherein the grains of the solid mesoporous material have an average size of from 100 μm to 5 mm.

3. The method of claim 1, wherein the particles are selected from the group consisting of nanometric particles, submicron particles, and micron particles.

4. The method of claim 1, wherein the solid inorganic exchanger compound is selected from the group consisting of zeolites, alkaline silicotitanates, and mixtures thereof.

5. The method of claim 1, wherein the particle content of the at least one solid inorganic exchanger compound is from 0.05% to 70% by weight of the total weight of the solid mesoporous material.

6. The method of claim 1, wherein the liquid medium is an aqueous liquid medium.

7. The method of claim 1, wherein the liquid medium is chosen from liquids and effluents from the nuclear industry and facilities and activities implementing radionuclides.

8. The method of claim 1, wherein, after having brought the liquid medium into contact, in a fixed bed, with the solid mesoporous material, the used fixed bed is directly transformed into a conditioning material.

9. The method of claim 1, wherein the grains of the solid mesoporous material have an average size of from 300 μm to 5 mm.

10. The method of claim 1, wherein the grains of the solid mesoporous material have an average size of from 300 μm to 500 μm.

11. The method of claim 1, wherein the particles have an average size of from 2 nm to 50 μm.

12. The method of claim 1, wherein the particles have an average size from 10 nm to 10 μm.

13. The method of claim 1, wherein the particles have an average size from 20 nm to 1 μm.

14. The method of claim 1, wherein the solid inorganic exchanger compound is sodium silicotitanate.

15. The method of claim 1, wherein the particle content of the at least one solid inorganic exchanger compound is from 10% to 40% by weight, of the total weight of the solid mesoporous material.
